(19) United States
(12) Patent Application Publication
(10) Pub. No.: US 2021/0378399 A1
(43) Pub. Date: Dec. 9, 2021

(54) DEVICE FOR THE STORAGE OF HANDGUNS

(71) Applicant: Andreas Hackl, Spittal an der Drau (AT)

(72) Inventor: Andreas Hackl, Spittal an der Drau (AT)

(21) Appl. No.: 17/283,121

(22) PCT Filed: Jul. 15, 2019
(86) PCT No.: PCT/EP2019/069010

§ 371 Date: Apr. 6, 2021

(30) Foreign Application Priority Data
Oct. 8, 2018 (AT) A 314/2018

(51) Int. Cl. A47B 81/00; E05B 47/00; E05B 73/00; F41A 23/18; F41A 17/44; F41A 17/54; F41A 17/06

(52) U.S. Cl. CPC A47B 81/005; E05B 47/0001; E05B 73/00; F41A 17/066; F41A 17/44; F41A 17/54; F41A 23/18

(57) ABSTRACT

The invention relates to a device for storing portable firearms, in particular handguns, such as pistols and revolvers, in a housing, which device comprises a rod that can be inserted into the barrel of the portable firearm. Furthermore, a pin is provided, which can be advanced through the trigger guard to a position in front of the trigger of the portable firearm. The advanced pin prevents the portable firearm from being removed from the housing and prevents the trigger from being pulled. Finally, a securing means for preventing the pin from being pushed back without authorization is provided, which securing means comprises an apparatus for entering a security code and/or an apparatus for identifying biometric features, such as fingerprints, faces or eyes, in particular the iris. A sensor, which senses the presence of a portable firearm arranged on the rod, activates the securing means.

### CROSS-REFERENCE TO RELATED APPLICATION

This Application is a Section 371 National Stage Application of International Application No. PCT/EP2019/069010, filed on Jul. 15, 2019, entitled “DEVICE FOR STORING PORTABLE FIREARMS”, which published as WO 2020/074146 A1, on Apr. 16, 2020, not in English, which claims priority to the Austrian Application No. A 314/2018, filed on Oct. 8, 2018, the contents of which are hereby incorporated by reference in their entireties.

### FIELD OF THE INVENTION

The invention relates to a device for storing handguns (portable firearms).

### BACKGROUND

For the storage of handguns, there are legal provisions on how handguns are to be stored so that unauthorized persons do not have access to handguns and cannot use them.

The usual lockable cabinets or boxes are often provided in inaccessible places, so that access to handguns takes considerable time.

Devices for storing/keeping handguns are known, which comprise a rod insertable into the barrel of the handgun.

### SUMMARY OF THE INVENTION

One of the ideas of the present invention is providing a device of the type mentioned above which, despite safe storage, allows authorized persons rapid access to the handgun.

Embodiments of the invention are the subject of the dependent claims.

In the device according to the invention, the handgun, in particular a portable firearm such as a pistol or a revolver, is safely stored by advancing or moving the barrel of the handgun over the rod whereby the advanced bolt engages through the trigger guard.

Since the device according to the invention has a safety means against unauthorized triggering of retraction of the pin or bolt, the removal of the handgun by unauthorized persons is prevented.

The device according to the invention allows the handgun to be stored in such a way that, in the case of a portable firearm (pistol or revolver), the handle protrudes and is at hand, so that the handgun can be removed and is ready for use by releasing the safety means and after the bolt engaging the trigger guard is retraced or moved back.

In an embodiment, the safety means of the device according to the invention is means for entering a security code and/or a means for recognizing biometric features, such as fingerprints, faces or eyes (irises thereof).

In a further embodiment of the device according to the invention, it may be provided that the device according to the invention is associated with a display device which displays at least one handgun stored therein.

This embodiment allows—for example if several handguns are safely stored in a device according to the invention—to indicate which handguns are stored. This is important, for example, in police stations and/or in the military, because it can then be determined whether the handgun assigned to a particular person is stored or has been removed. In the case of a withdrawn handgun, it is also possible to check whether the handgun has been withdrawn by a person who is on duty and is supposed to carry the handgun.

In some embodiments it is advantageous in the context of the invention that the advancement of the bolt is triggered by the sensor detecting the presence of a handgun.

### BRIEF DESCRIPTION OF THE DRAWINGS

Further details and features of the invention will be apparent from the following description of a preferred embodiment with reference to the drawings. It shows:

FIG. 1 a sectional view of the device according to the invention with inserted handgun,

FIG. 2 the device according to the invention with the handgun removed,

FIG. 3 the position of the device of FIG. 2 in another view, and

FIG. 4 the device in the position of FIG. 1 in another view.

### DETAILED DESCRIPTION OF EMBODIMENTS

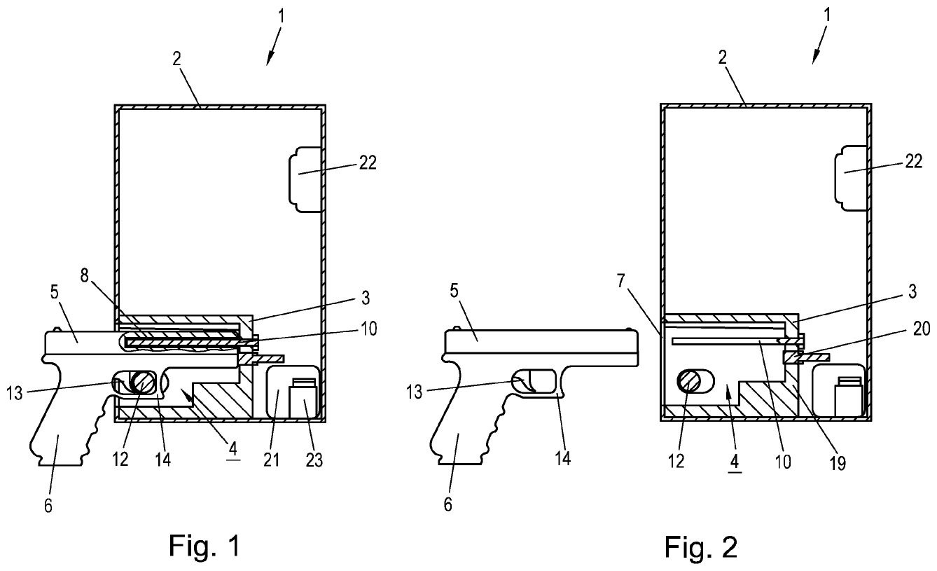

A device 1 according to the invention comprises a housing 2, in particular as a steel casing or steel housing. In the housing 2, a separate space 4 is provided, separated by a housing part 3, into which a handgun 5, which in the exemplary embodiment is a pistol, can (partly) be inserted, wherein—as shown in FIG. 1—the handle of grip 6 of the handgun 5 protrudes from the housing 2. A rod 10 is provided inside the housing part 3, which is attached to a wall, in particular the rear wall 19, of the housing part 3. When a handgun 5 is stowed, the rod 10 engages the barrel 8 of the handgun 5.

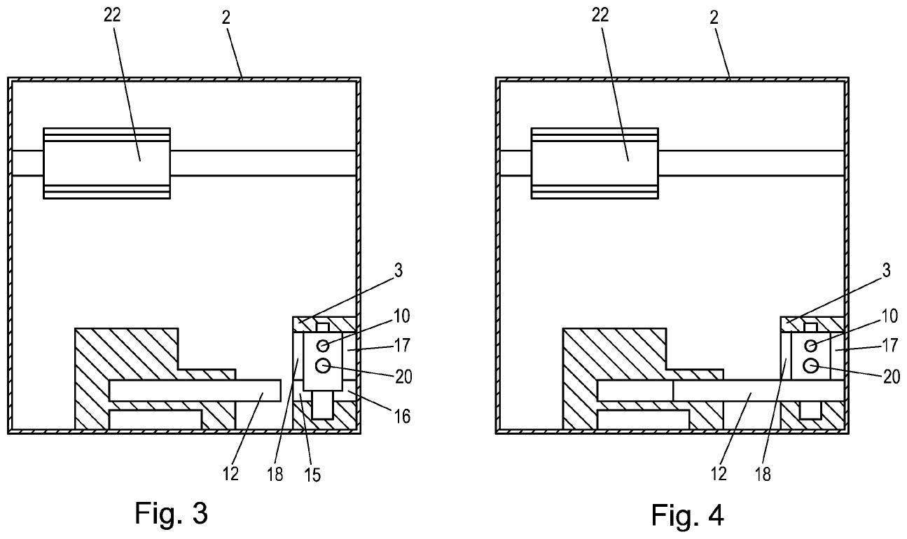

In addition, a bolt 12 is provided which (see e.g. FIGS. 3 and 4) can be moved from a ready position (FIG. 3) to an operative position (FIG. 4). In the operative position, the bolt 12 protrudes in front of a trigger 13 through a trigger guard 14 of the handgun 5 inserted, in the example as shown, the pistol. By the bolt 12 being advanced through the trigger guard 14 in front of the trigger 13, the handgun 5 is prevented from being removable by the advanced bolt 12 (FIG. 1 and FIG. 4).

FIG. 4 shows that in its operative position the bolt 12 extends through openings 15 and 16 in the walls 17 and 18 of the housing part 3 so that it is securely held.

To move the bolt 12 from its ready position (FIG. 3) to its operative position (FIG. 4), any drive can be provided, for example an electromotive drive.

A sensor 20 is provided in the rear wall 19 of the housing part 3, which is opposite the access opening 7 of the housing part 3. The sensor 20 is provided on the rear wall 19 of the housing part 3 below the rod 10, and detects the presence of a handgun 5 in the housing part 3 of the device 1 according to the invention. As soon as the sensor 20 detects the presence of a handgun 5, the bolt 12 is advanced from its ready position (FIG. 3) to its operative position (FIG. 4) so that the handgun 5 is safely stored because the bolt 12 projects through the trigger guard 14 of the handgun 5.

An internal power storage 21 is provided in the housing 2 as a power supply. For charging the power storage 21, the housing 2 comprises a charging socket, via which the power storage 21 can be supplied with electrical energy and charged from a power supply system or power grid via a power supply unit.

When the device 1 is connected to a power supply system via the charging socket, the safety means of the device 1 can also be activated and deactivated when the internal power storage 21 is completely discharged.

The device 1 according to the invention may also be equipped with a connection for an external power source in the form of a power storage device (“power bank”) that can be charged, for example, via solar cells. The connection for the external power source may be combined with the connection (charging socket) for a charging cable for the internal power storage 21. When the device 1 is connected to an external power source, the safety means of the device 1 can be activated to store a handgun 5 and can also be deactivated to remove a handgun 5 when the internal power storage 21 is exhausted (discharged) and there is a power failure.

The electronic control unit 22, the function of which will be described below, is also provided within the housing 2.

In order to provide access into the housing 2 for maintenance or malfunction, an access opening can be opened after releasing a mechanical locking device comprising a lock 23. The access opening can only be opened by a (master) key kept by an authorized person. If an authorized person wants to remove the handgun 5, which is stored as shown in FIG. 1, the security means preventing retraction of the bolt 12 must be unlocked. This can be achieved by entering a code via a keypad or by capturing biometric data (fingerprint, facial recognition, iris recognition). This ensures that only the authorized person can remove the handgun 5, in particular only the handgun 5 belonging to him or assigned to him. Removal of the handgun 5 is quick and easy after unlocking the safety means and with the bolt 12 retracted, because the handle 6 of the handgun 5—as shown in FIG. 1—protrudes from the housing 2 of the device 1.

It is also an advantage of the device 1 according to the invention that a handgun 5 can be stored in the device 1 even with the magazine inserted. The device 1 according to the invention can be mounted on any wall by fixing the housing 2.

The electronic control unit 22 provided inside the housing 2 causes the bolt 12 to be retracted from its operative position after the safety means has been unlocked in the manner previously described, so that the handgun 5 can be removed.

The device 1 according to the invention may be connected to a display device indicating that a handgun 5 is stored in the device 1.

This embodiment is particularly advantageous when several handguns 5 are stored in the housing 2 in respective housing parts 3 provided for this purpose, which is important, for example, in police stations or in the military.

The display device also allows to determine whether a handgun 5 is stored or not, so that it can be determined whether a handgun has been removed by a person (police officer or soldier) who is on duty and who must carry the handgun 5 with him.

In the device 1 according to the invention, it may also be provided that the advancement or movement of the bolt 12 is stopped if the handgun 5 is not properly inserted, for example with its barrel not properly pushed over the rod 10 into the housing part 3 of the device 1 according to the invention.

In the device 1 according to the invention, it may also be provided that the advancement of the bolt 12 is interrupted if an attempt is made to withdraw the handgun 5 from the device during the advancement of the bolt 12, i.e. the handgun 5 is removed from the sensor 20. In this way, possible damage to the handgun 5 can be prevented.

It is also advantageous with the device according to the invention that a stored handgun 5 is secured, since the bolt 12 prevents the trigger 13 from being actuated.

In certain embodiments of pistols (for example, Glock pistols), repeating is also not possible. Only the magazine can be attached or removed, since the handle 6—as shown in FIG. 1—protrudes from the device 1 according to the invention.

In summary, an exemplary embodiment example can be described as follows:

A device 1 for storing handguns 5, in particular handguns such as pistols and revolvers, in a housing 2 comprises a rod 10 which can be inserted into the barrel 8 of the handgun 5. Furthermore, a bolt 12 is provided which can be advanced through the trigger guard 14 and in front of the trigger 13 of the handgun 5. The advanced bolt 12 prevents, on the one hand, the handgun 5 from being removed from the housing 2 and, on the other hand, the trigger 13 from being operated. Finally, a safety means against unauthorized retraction of the bolt 12 is provided, comprising a device for entering a security code and/or a device for recognizing biometric features, such as fingerprints, faces or eyes, in particular the iris. A sensor 20 placed on the rod 10 detecting the presence of a handgun 5 activates the safety means.

1. Device for storing handguns, comprising a rod insertable into the barrel of the firearm,
a bolt adapter to be insertable through the trigger guard and in front of the trigger lever of the handgun and
a safety means against unauthorized retraction of the bolt.

2-13. (canceled)

14. Device according to claim 1, wherein the device is configured for storing portable firearms, such as pistols and revolvers.

15. Device according to claim 1, wherein a sensor is provided which detects the presence of a handgun placed on the rod.

16. Device according to claim 1, wherein the bolt is movable transversely to the longitudinal extension of the rod.

17. Device according to claim 1, wherein the security means comprises at least one of a device for entering a security code or a device for recognizing biometric features.

18. Device according to claim 5, wherein the device for recognizing biometric features is configured for recognizing fingerprints, faces or iris.

19. Device according to claim 1, wherein the rod and the bolt are provided in a housing.

20. Device according to claim 7, wherein the rod and the bolt are provided in at least one housing part separated from the interior of the housing.

21. Device according to claim 3, wherein the sensor is arranged below the rod.

22. Device according to claim 1, wherein an adjustment drive, is associated with or in connection with the bolt.

23. Device according to claim 10, wherein the adjustment drive is an electromotive adjustment drive.

24. Device according to claim 1, wherein the device comprises a power connection and a power storage.

25. Device according to claim 1, wherein the device comprises a connection for an external power storage.

26. Device according to claim 7, wherein the device comprises a display device which displays a handgun stored in the device and assigned to the device.

27. Device according to claim 7, wherein the housing comprises at least one of a lockable access opening or a switch lock.

28. Device according to claim 3, wherein the advancement of the bolt is triggerable by the sensor detecting the presence of a handgun.
